(19) United States
(12) Patent Application Publication
(10) Pub. No.: US 2026/0340847 A1
(43) Pub. Date: Oct. 29, 2026

(54) 3-DIMENSIONAL INFORMATION PROCESSING APPARATUS, 3-DIMENSIONAL INFORMATION PROCESSING METHOD, AND STORAGE MEDIUM

(71) Applicant: CANON KABUSHIKI KAISHA, Tokyo (JP)

(72) Inventor: Masato NAKATA, Kanagawa (JP)

(21) Appl. No.: 19/577,621

(22) Filed: Mar. 25, 2026

(30) Foreign Application Priority Data
Apr. 28, 2025 (JP) 2025-074367

(51) Int. Cl. G06T 7/50; G06T 3/40

(52) U.S. Cl. CPC G06T 7/50; G06T 3/40; G06T 2207/10028; G06T 2210/36

(57) ABSTRACT

In a 3-dimensional information processing apparatus, first 3-dimensional shape information that has been acquired by a distance measurement apparatus and image information that has been acquired by an image acquisition apparatus is used, second 3-dimensional shape information is generated that has a high resolution in comparison to the first 3-dimensional shape information, and using measurement time information for the first 3-dimensional shape information, the first 3-dimensional shape information is corrected.

### BACKGROUND OF THE INVENTION

### Field of the Invention

The present invention relates to a 3-dimensional information processing apparatus, a 3-dimensional information processing method, a storage medium, and the like.

### Description of the Related Art

In object recognition, video image creation, game creation, and the like within the fields of autonomous driving and robotics, the need for high-resolution 3-dimensional information is increasing. Although there are many cases in which distance information acquisition devices are used in the acquisition of 3-dimensional information acquisition, it is also often the case that the resolution of the distance information that is acquired is inferior in comparison to image information that is acquired using a digital camera and the like. Therefore, there are many cases in which methods are used that supplement the distance information using image information in order to obtain high-resolution 3-dimensional information.

There are many cases in which the distance information is acquired as point cloud data using a LiDAR (Light Detection and Ranging) device. However, the inconsistencies in measurement in these devices are large, and therefore, there is the problem that the precision deteriorates for high-resolution 3-dimensional information that has been generated by combining distance information with image information in which the subject is still.

In relation to this problem, in Japanese Unexamined Patent Application, First Publication No. 2022-140119, after having graphed out point cloud data, which is the distance information, a plurality of image information is used, and the point cloud noise is eliminated by updating the graph weight and correcting the point cloud data. In addition, in Japanese Unexamined Patent Application, First Publication No. 2023-21910, a depth flow is acquired by the analysis of a plurality of LiDAR frame data, and the point cloud data noise is reduced.

However, in the method of Japanese Unexamined Patent Application, First Publication No. 2022-140119, the processing costs for making the graphs are high, and real-time processing is difficult, and in addition, the method assumes a plurality of cameras, and therefore, cannot be applied to a system configured by a single camera. In addition, in the method of Japanese Unexamined Patent Application, First Publication No. 2023-21910, in order to obtain the depth flow, data analysis for a plurality of frames is necessary, and therefore, there is the concern that 3-dimensional information acquisition processing cannot be performed for objects that move rapidly within the angle of view.

### SUMMARY

A 3-dimensional information processing apparatus uses first 3-dimensional shape information that has been acquired by a distance measurement apparatus and image information that has been acquired by an image acquisition apparatus, and generates second 3-dimensional shape information that has a high resolution in comparison to the first 3-dimensional shape information; and uses measurement time information for the first 3-dimensional shape information, and corrects the first 3-dimensional shape information.

Further features of the present disclosure will become apparent from the following description of embodiments with reference to the attached drawings.

### BRIEF DESCRIPTION OF THE DRAWINGS

FIG. 1 is a system block diagram showing a configurational example of a 3-dimensional information processing apparatus 101 in a First Embodiment of the present disclosure.

FIG. 2 is a functional block diagram showing a configurational example of the 3-dimensional information processing apparatus 101 in the First Embodiment.

FIG. 3 is a flowchart showing a processing example of the 3-dimensional information processing apparatus 101 in the First Embodiment.

FIG. 4 is a flowchart showing a processing example for 3-dimensional shape information correction in the First Embodiment.

FIG. 5 is a diagram for explaining the processing contents of the 3-dimensional shape information correction in the First Embodiment.

FIGS. 6A - 6C are diagrams for explaining the processing contents of the 3-dimensional shape information correction in the First Embodiment.

FIG. 7 is a flowchart showing a processing example of the 3-dimensional shape information correction in a Second Embodiment and a Third Embodiment.

FIGS. 8A and 8B are diagrams for explaining the processing contents of the 3-dimensional shape information correction in the Second Embodiment.

FIGS. 9A - 9C are diagrams for explaining the processing contents for the 3-dimensional shape information correction in the Third Embodiment.

FIG. 10 is a flowchart showing a processing example for the 3-dimensional shape information correction in the Fourth Embodiment.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate description will be omitted or simplified.

### First Embodiment

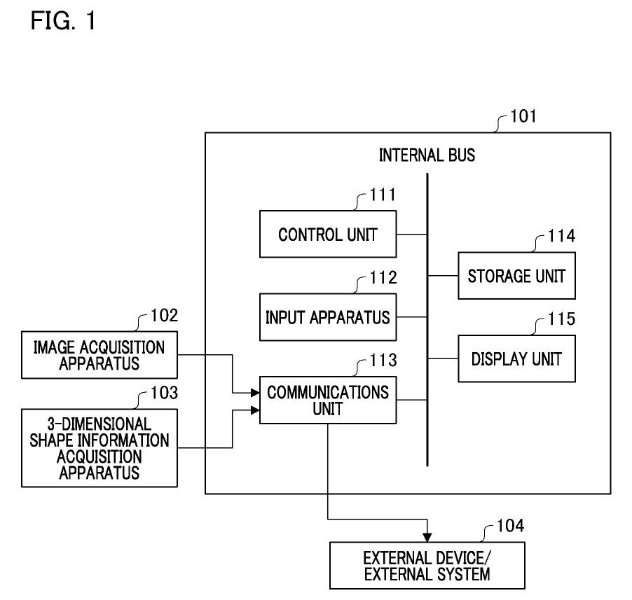

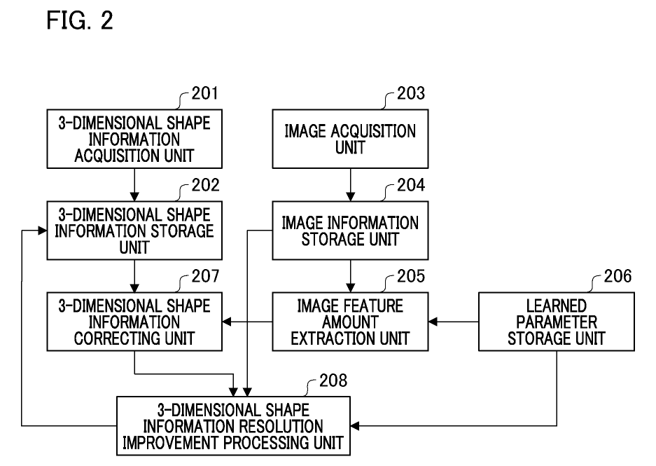

The system configuration according to an embodiment of the present disclosure, as well as the data and processing flow according to an embodiment of the present disclosure will be explained with reference to FIGS. 1 and FIG. 2.

FIG. 1 is a system block diagram showing a configurational example of a 3-dimensional information processing apparatus 101 in the First Embodiment of the present disclosure. In FIG. 1, the 3-dimensional information processing apparatus 101 is provided with a control unit 111, an input apparatus 112, a communications apparatus 113, a storage unit 114, and a display apparatus 115.

The control unit 111 is, for example, a CPU (Central Processing Unit), a GPU (Graphical Processing Unit), and an FPGA (Field Programmable Gate Array).

The input apparatus 112 is a keyboard and a mouse for operating the 3-dimensional information processing apparatus. The communications apparatus 113 is an interface for performing the reception of information from an external device. The communications apparatus 113 is, for example, ethernet, MIPI, I2C, SPI, HDMI (registered trademark), USB, and the like.

Note that MIPI is an abbreviation of Mobile Industry Processing Interface, I2C is an abbreviation of Inter-Integrated Circuit, and SPI is an abbreviation of Serial Peripheral Multimedia Interface. In addition, HDMI (registered trademark) is an abbreviation of High-Definition Multimedia Interface, and USB is an abbreviation of Universal Serial Bus.

The storage unit 114 is a ROM (read Only Memory), a RAM (Random Access memory), an HDD (Hard Disk Drive), an SSD (Solid State Drive), and the like.

The storage unit 114 stores computer programs for operating the 3-dimensional information processing apparatus, computer programs for performing 3-dimensional information processing in the control unit, input data, and each type of parameter for apparatus operations. The display apparatus 115 is an output apparatus for operating the 3-dimensional information processing apparatus, and drawing input-output data, and is equipped with an LCD (Liquid Crystal Display), and the like.

The image acquisition apparatus 102 is an image capturing apparatus that has been provided with an image sensor such as, for example, a CCD, an MOS, a CMOS, and the like. Note that CCD is an abbreviation of Charge Coupled Device, MOS is an abbreviation of Metal Oxide Semiconductor, and CMOS is an abbreviation of Complementary Metal Oxide Semiconductor.

A 3-dimensional shape information acquisition apparatus 103 is a LiDAR (Light Detection and Ranging) device, and the like that acquires distance information using laser light irradiation and reception of the reflected light therefrom.

In the LiDAR device, distance measurement is executed based on a time difference from when a light beam is irradiated until the reflected light is detected (ToF), and distance data groups having a predetermined spatial resolution are thereby generated.

The distance data can be converted into a 3-dimensional coordinate system based on the irradiation direction of the light beam. The gathering of 3-dimensional coordinates for an object surface (point cloud data) represents the 3-dimensional shape of the object surface, and therefore, this can be treated as 3-dimensional shape data. Note that the distance may also be calculated by using the phase difference for the irradiated light and the reflected light.

Note that the 3-dimensional shape information acquisition apparatus 103 may also be, for example, a stereo camera. In this case, one of a pair of stereo cameras may also serve as the image acquisition apparatus 102.

Conversely, the 3-dimensional shape information acquisition apparatus 103 may also be, for example, a CMOS image sensor with an image plane phase detection method. In this case, it may also be made such that the image acquisition apparatus 102 is made, for example, a CMOS image sensor with an image plane phase detection method, and the distance data and the image data are both acquired from the image acquisition apparatus 102. That is, the 3-dimensional shape information acquisition apparatus 103 may also serve as the image acquisition apparatus 102.

In this context, in the present embodiment, the 3-dimensional shape information acquisition apparatus 103 functions as a distance measurement apparatus, and acquires the first 3-dimensional shape information using at least one of electromagnetic waves, and acoustic waves. Note that the first 3-dimensional shape information in the present embodiment includes point cloud information as has been explained above.

An external device/external system 104 is a device that has the goal of recording, editing, and using the high resolution depth data that has been acquired by the 3-dimensional information processing apparatus, and is a hardware controller, a work station, a server, and the like. Note that the configuration that has been shown in FIG. 1 is merely one example of a system configuration, and the present disclosure is not limited thereto.

Note that at least a portion of the image acquisition apparatus 102, the 3-dimensional shape information acquisition apparatus 103, the external device/external system 104, and the like may also be included in the 3-dimensional information processing apparatus 101.

FIG. 2 is a functional block diagram showing a configurational example of the 3-dimensional information processing apparatus 101 of the First Embodiment, and the processing according to the 3-dimensional information processing apparatus 101 will be explained with reference to FIG. 2. Note that a portion of the blocks that are shown in FIG. 2 are realized by a CPU and the like that serves as computer, which is not shown, and that is included in the 3-dimensional information processing apparatus executing a computer program that has been stored on a memory that serves as a storage medium, which is also not shown.

However, a portion or the entirety of these may also be made so as to be realized by hardware. As the hardware, an application specific integrated circuit (ASIC), a processor (a reconfigurable processor, a DSP), and the like can be used. In addition, each block that is shown in FIG. 2 does not need to be housed in the same body, and may also be configured by separate apparatuses that have been connected to each other via a signal path.

The 3-dimensional information processing apparatus 101 has a 3-dimensional shape information acquisition unit 201, a 3-dimensional shape information storage unit 202, an image acquisition unit 203, an image information storage unit 204, an image feature amount extraction unit 205, a learned parameter storage unit 206, and a 3-dimensional shape information correcting unit 207. In addition, the 3-dimensional information processing apparatus 101 is also provided with a 3-dimensional shape information resolution improvement processing unit 208.

The 3-dimensional shape information acquisition unit 201 acquires 3-dimensional shape information to serve as the first 3-dimensional shape information using the 3-dimensional shape information acquisition apparatus 103, which serves as a distance measurement unit, and stores the first 3-dimensional shape information in the 3-dimensional shape information storage unit 202. The 3-dimensional shape information in the present embodiment includes distance information for from the 3-dimensional shape information acquisition apparatus 103 until the target subject, and measurement time information that was acquired at the same time as the acquisition of the distance information.

The above-described distance information may be any of depth information, relative distance information, and absolute distance information, and is provided in a point cloud format, a depth map format, and the like. In addition, the measurement time information includes information according to the reflection intensity of the target object, reflected wave waveshape information for the received light, noise information, and the like. That is, the measurement time information includes information relating to a reflected wave corresponding to the first 3-dimensional shape information from when the first 3-dimensional shape information was acquired, and the information relating to the reflected wave also includes the reflection intensity.

The image acquisition unit 203 acquires image information using the image acquisition apparatus 102, and stores the information in the image information storage unit 204. The image information is one or more of either of a color image, and a monochrome image.

The image feature amount extraction unit 205 acquires parameters for use in feature amount extraction processing using the learned parameter storage unit 206 of the storage unit 114, and extracts image feature amounts. The image feature amounts include at least one of pixel values in the image information, color space coordinate values, object search results for inside the image, and segmentation results in which objects have been identified.

The 3-dimensional shape information correcting unit 207 corrects the 3-dimensional shape information that was collected by the 3-dimensional shape information acquisition unit 201, and has been stored on the 3-dimensional shape information storage unit 202. That is, the 3-dimensional shape information correcting unit 207 uses the measurement time information for the first 3-dimensional shape information, and corrects the first 3-dimensional shape information. Note that the correction processing may also use the image feature amounts from the image feature amount extraction unit 205.

That is, the 3-dimensional shape information correcting unit 207 may also be made so as to correct the first 3-dimensional shape information by using at least one of the first 3-dimensional shape information and the distance measurement information, together with the image feature amounts that have been extracted from the image information.

The 3-dimensional shape information resolution improvement processing unit 208 acquires high-resolution 3-dimensional shape information using resolution improvement processing that uses low resolution 3-dimensional shape information and high-resolution image information. The 3-dimensional shape information resolution improvement processing unit 208 uses the first 3-dimensional shape information that has been acquired by the distance measurement unit, and the image information that has been acquired by the image acquisition apparatus, and functions as a resolution improvement processing unit that generates second 3-dimensional shape information that has a higher resolution in comparison to the first 3-dimensional shape information. Note that the second 3-dimensional shape information in the present embodiment includes point cloud information.

Note that for example, inference processing using a neural network is used as the resolution improvement processing. When performing this processing, it is sufficient if a method such as an SPN (Spatial Propagation Network) model base, which is one representative method for inference processing, is used. The learned parameter that is used in the inference processing uses information that has been stored in advance on the learned parameter storage unit 206.

The high-resolution 3-dimensional shape information from after the resolution improvement processing in the 3-dimensional shape information resolution improvement processing unit 208 is stored in the 3-dimensional shape information storage unit 202 in the storage unit 114. Note that it is preferable if the 3-dimensional shape information and the image information are information that has been acquired at the same time, and it is preferable if the information acquisition timing is synchronized for the 3-dimensional shape information acquisition unit 201 and the image acquisition unit 203.

As the synchronization method for when doing so, there is the method of one from among the 3-dimensional information processing apparatus 101, the image acquisition apparatus 102, and the 3-dimensional shape information acquisition apparatus outputting a signal for synchronization, and transmitting this to the other apparatuses. In addition, each apparatus may also be synchronized by PTP (Precision Time Protocol), which is a time synchronization protocol for use in Ethernet.

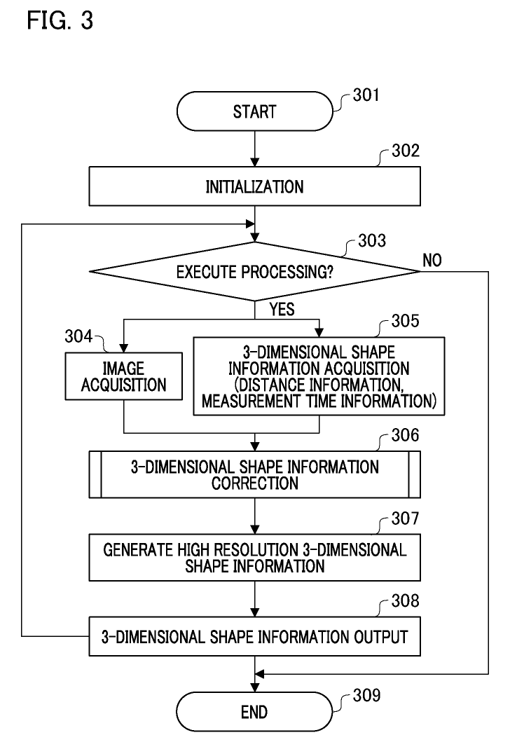

FIG. 3 is a flowchart showing a processing example for the 3-dimensional information processing apparatus 101 in the First Embodiment. Note that the processes for each step of the flowchart in FIG. 3 are performed in order by a CPU and the like that serves as a computer inside of the 3-dimensional information processing apparatus 101 executing a computer program that has been stored on a memory.

Step S301 of FIG. 3 is a step for starting the processing flow of FIG. 3 by loading the computer program that has been stored in advance on the storage unit 114. Step S302 is an initializing step that loads the parameters for program operations from the storage unit 114, and performs settings via the input apparatus 112, and the like.

Step S303 is a step for determining whether or not to continue executing the processing. Step S304 is a step for acquiring the image information that has been acquired by the image acquisition unit 203 and stored on the image information storage unit 204.

Step S305 is a step for acquiring the distance information, which is the 3-dimensional shape information that has been acquired by the 3-dimensional shape information acquisition unit 201 and stored on the 3-dimensional shape information storage unit 202, and the measurement time information for the distance information. That is, during step S305, for example, the point cloud data and reflection intensity data are acquired based on data from LiDAR.

Step S306 is a 3-dimensional shape information correction step for correcting the 3-dimensional shape information that has been acquired during step S30. In this context, step S306 functions as a 3-dimensional shape information correcting step for using the measurement time information for the first 3-dimensional shape information and correcting the first 3-dimensional shape information.

Step S307 is a step for using the image information that has been acquired by the image acquisition unit 203 and stored on the image information storage unit 204, and the 3-dimensional shape information after correction by step S306, and generating high resolution 3-dimensional shape information.

In this context, step S307 functions as a resolution improvement processing step that uses the first 3-dimensional shape information that has been acquired by the distance measurement apparatus and the image information that has been acquired by the image acquisition apparatus and generating second 3-dimensional shape information that has a higher resolution in comparison to the first 3-dimensional shape information.

Step 308 is a step for outputting the high resolution 3-dimensional shape information that was generated during step S307 to the storage unit 114, the display apparatus 115, and the communications unit 113 via the external device/external system 104. Step S309 is a step for completing the processing flow of FIG. 3. Note that the processing flow of FIG. 3 is cyclically executed in the image acquisition unit for example, for each frame period.

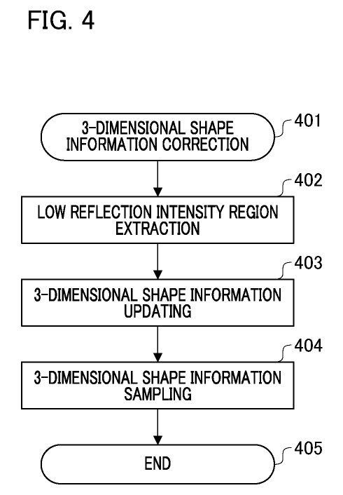

FIG. 4 is a flowchart showing a processing example for the 3-dimensional shape information correction in the First Embodiment. Using FIG. 4, the flow for the 3-dimensional shape information correction processing for step S306 will be explained. Note that the processes for each step of the flowchart in FIG. 4 are executed in order by a CPU and the like that serves as a computer inside of the 3-dimensional information processing apparatus 101 executing a computer program that has been stored on a memory.

Step S402 of FIG. 4 is a step for extracting a low reflection intensity region based on the measurement time information for the 3-dimensional shape information. Step S403 is a step for updating the 3-dimensional shape information. Step S404 is a step for sampling the 3-dimensional shape information. Step S405 is a step for completing the processing flow for the 3-dimensional information correction of FIG. 4.

During the low reflection intensity region extraction processing for step S402, a region that is estimated to have a low reflection intensity is extracted from among the 3-dimensional shape information based on the information according to the reflection intensity for the target object, which is the measurement time information , the reflected wave waveshape information for the received light, the noise information, and the like.

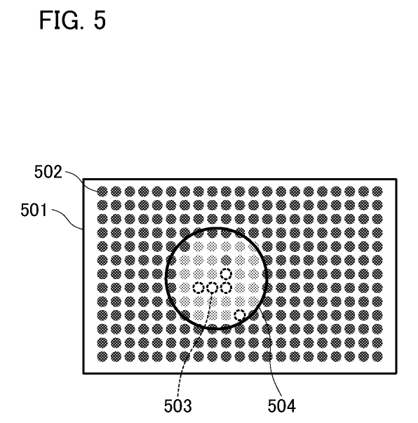

FIG. 5 is a diagram for explaining the processing contents for the 3-dimensional shape information in the First Embodiment, and shows the reflection intensity information, which is the measurement time information for the 3-dimensional shape information that was acquired by the 3-dimensional shape information acquisition unit 201. Using FIG. 5, the low reflection intensity region extraction processing for step S402 of FIG. 4 will be explained.

In a case in which a 3-dimensional shape information acquisition apparatus 103 that detects reflected waves off of the target from a light that has been irradiated is used, such as a case in which a LiDAR apparatus is used, it is sufficient if the reflectance ratio is used as the reflection intensity information. In addition, statistical information relating to the time response results for the reflected waves that have been acquired by the LiDAR, for example, the time change information for the number of received light photons, and the like may also be used as the reflection intensity information

In addition, in a case in which the reflected wave waveform information is used, and in cases in which a specific peak value is used from among a plurality of peak values according to multiple reflections, the reflection intensity may also be estimated by taking into account the effects of noise using the shape of the waveform, half value width information, and the like.

In FIG. 5, the reflection intensity information is 2 -dimensionally represented, and 502 represents the measurement point with a circular mark. The measurement point 503 (the white circular mark made of a broken line) is made the measurement point with a small reflection intensity. A pixel region of a predetermined size that includes a number of measurement points with small reflection intensities that is equal to or greater than a predetermined ratio is extracted as the low reflection intensity region 504. In a case in which point cloud information and voxel information are used as the 3-dimensional shape information, it is sufficient if the low reflection intensity region is searched for in the 3-dimensional space.

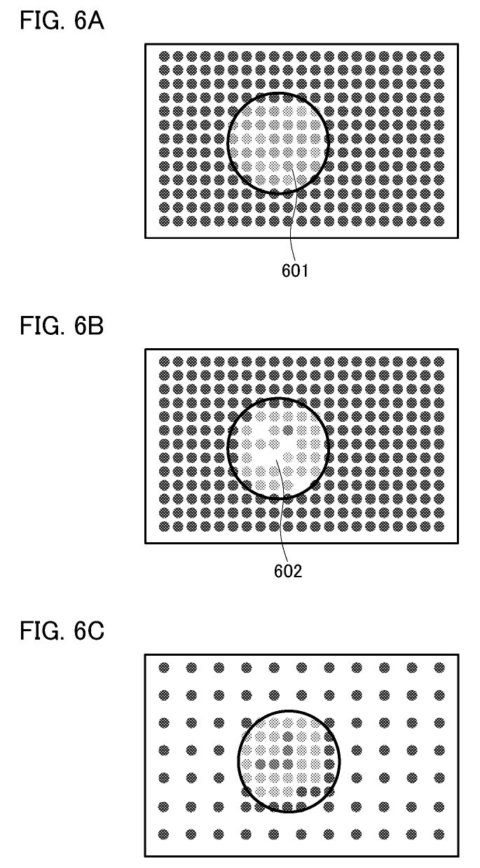

FIGS. 6A - C are diagrams explaining the processing contents for the 3-dimensional shape information correction in the First Embodiment, and show distance maps as the 3-dimensional shape information. Using FIGS. 6A - C, the 3-dimensional shape information update processing for step S403, and the results of the 3-dimensional shape information sampling processing for step S404 will be explained.

FIG. 6A is a diagram showing an example of averaging the 3-dimensional shape information for the measurement points in the low reflection intensity region 504, and updating the 3-dimensional shape information with this average value during the 3-dimensional shape information update processing for step S403.

In the case of a 3-dimensional shape information acquisition apparatus that irradiates a light and detects the reflected light, such as a LiDAR apparatus, there is a high possibility that a measurement point that is in the vicinity of a different measurement point that has a low reflection intensity in a specific frame will become a measurement point with a low reflection intensity in the next frame or later. Therefore, in the present embodiment, the 3-dimensional shape information correcting unit performs averaging processing using neighborhood point clouds for the low reflection intensity regions.

In this manner, in the present embodiment, the low reflection intensity regions in a specific frame are extracted and averaged, and therefore, it becomes possible to decrease measurement inconsistencies in the time direction by executing the same processing for the next and proceeding frames.

FIG. 6B is a diagram showing an example in which during the 3-dimensional shape information update processing for step S403, the 3-dimensional shape information for the measurement points in the low reflection intensity region 504 is updated by outlier value elimination using the reflection intensity information.

As the outlier value elimination processing, for example, processing is used that eliminates measurement points that have a reflection intensity of equal to or less than a threshold value that has been determined in advance. Conversely, processing may also be used that finds the frequency distribution for the reflection intensity in the low reflection intensity region 504, and eliminates measurement points for which the inconsistency from a median value is large as the outlier values.

Although according to the outlier value elimination processing, there are cases in which during averaging processing such as, for example, the average processing in FIG. 6(A) , 3-dimensional information having a high reflection intensity and low noise is lost due to the averaging processing, it is possible to avoid such problems during the outlier value elimination processing.

FIGS. 6 (C) is a diagram showing an example of 3-dimensional shape information sampling using reflection intensity information during the 3-dimensional shape information sampling processing of step S404. The processing that is shown in FIGS. 6 (C) is executed in a case in which the resolution of the 3-dimensional shape information that has been acquired by the 3-dimensional shape information acquisition unit 201 is sufficient in comparison to the resolution of the 3-dimensional shape information that is necessary in the 3-dimensional shape information resolution improvement processing unit 208.

That is, as is shown in FIGS. 6 (C), the sampling density for the measurement points for the low reflection intensity region 504 are made high in comparison to the sampling density for the measurement points for outside of the low reflection intensity region. That is, the 3-dimensional shape information correcting unit makes the sampling density high for the point clouds for the low reflection intensity region.

At this time, in the 3-dimensional shape information resolution improvement processing unit 208, high resolution image information is used as a supplement and high resolution 3-dimensional shape information is generated based on the 3-dimensional shape information that has a lower resolution in comparison to the image information.

Therefore, if there are noise errors and the like in the 3-dimensional shape information for the measurement points, it becomes such that these errors are propagated, and the precision of the high resolution 3-dimensional information post supplementation deteriorates. In the low reflection intensity region 504, the measurement noise is larger than in comparison to other regions, and therefore, the larger that the number of measurement points that are supplied to the 3-dimensional shape information resolution improvement processing unit 208 becomes, it is possible to decrease the error effects post supplementation. Therefore, it is possible to acquire high resolution 3-dimensional shape information in which the measurement inconsistencies have been decreased.

Note that according to the processing method that was explained in FIGS. 6(A), and (B) , it may also be made such that updating is only performed for the 3-dimensional shape information during the 3-dimensional shape information update processing for step S403, and it may also be made such that the 3-dimensional shape information sampling processing for step S404 that was shown in FIGS. 6 (C) is performed at the same time. That is, the processing methods that have been explained in FIGS. 6 (A) - (C) may also be appropriately combined.

### Second Embodiment

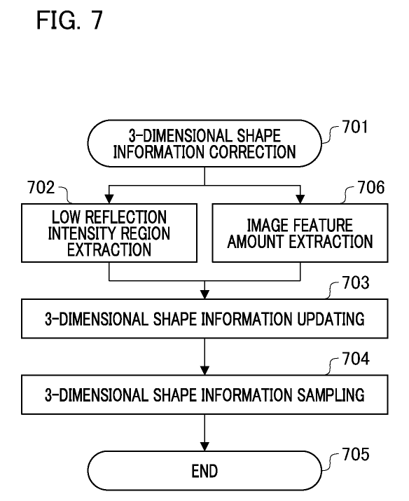

FIG. 7 is a flowchart showing an example of the processing for the 3-dimensional shape information correction in the Second Embodiment and the Third Embodiment. Note that the processes for each step of the flowchart in FIG. 7 are performed in order by a CPU and the like that serves as a computer inside of the 3-dimensional information processing apparatus 101 executing a computer program that has been stored on a memory.

In addition to the contents of the flowchart in FIG. 4, FIG. 7 adds a step for extracting image feature amounts as the step S706 in FIG. 7. Note that the step S701 to step S705 of FIG. 7 correspond to the step S401 to step S405 of FIG. 4.

During step S706, along with acquiring the image information that was stored in the image information storage unit 204, a learned weight relating to the image feature amount extraction is acquired from the learned parameter storage unit 206, and the feature amounts for the image information are extracted. The feature amounts that are extracted are, for example, the luminance and color information for a pixel, object detection results such as people, objects, and the like, segmentation results, and the like.

That is, during step S706, the 3-dimensional shape information correcting unit performs point cloud classification based on segmentation processing for the image, and extracts the feature amounts for the image information.

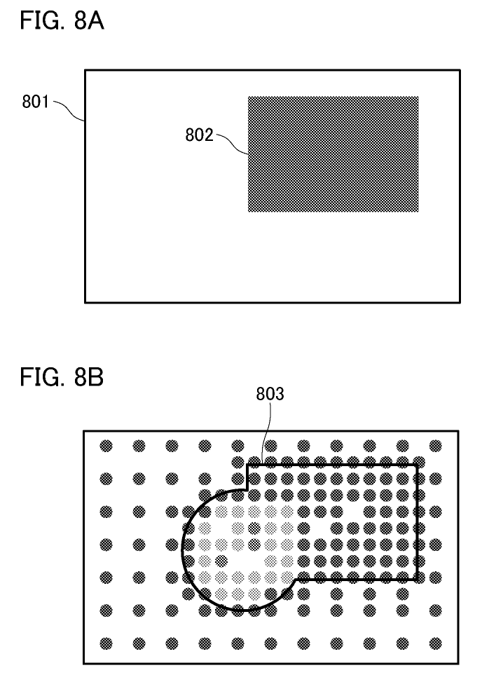

FIGS. 8 (A), and (B) are diagrams for explaining the processing contents for the 3-dimensional shape information correction in the Second Embodiment. The 3-dimensional shape information update processing for step S703, and 3-dimensional shape information sampling processing for step S704, which use the image feature amounts, will be explained with reference to FIGS. 8 (A), and (B).

In FIG. 8(A) , 801 is image information, and in the 3-dimensional shape information acquisition apparatus 103 such as a LiDAR apparatus and the like, it is made such that a weak subject 802 (there are cases in which below, this is referred to as a 3D weak subject) that has a large amount of measurement noise is present in the image.

There are cases in which as the weak subject, for which the degree of reliability for the distance information that is acquired by the LiDAR becomes low, the subject is, for example, a transparent object, and cases in which this is a black colored object, and the like. The weak subject 802 inside of the image may be extracted using only the luminance values and color information, and this may also be extracted by inference processing using a deep learning model and parameters for use in object detection that have been learned in advance.

Although during the 3-dimensional information update processing for step S403 of the Third Embodiment, only the 3-dimensional shape information and the measurement time information was used, in the 3-dimensional shape information update processing for step S703, the above describe image feature amount information is also used together with this information.

That is, the reflection intensity information that was shown in FIG. 5, and the image feature amount information for FIGS. 8 (A) are used, and the updating and sampling of 3-dimensional shape information that were explained in the First Embodiment are executed for the region 803, for which the union of sets has been taken for the low reflection intensity region 504 and the weak subject 802.

In FIGS. 8 (B), the 3-dimensional shape information is shown for a case in which outlier value elimination processing is performed during the 3-dimensional shape information update processing for step S703, and correction processing has been performed in which 3-dimensional shape information sampling was performed that made the sampling density inside the region 803 higher than the sampling density outside of the region 803.

Note that during step S703, it may also be made such that averaging processing such as that shown in FIGS. 6 (A), and FIGS. 6 (B) is performed on the same subject region based on the feature amounts for the image information.

By performing the above-described processing, it becomes possible to decrease the measurement inconsistencies for the 3-dimensional shape information acquisition apparatus even in a case in which measurement values with a high amount of measurement noise, and subjects for which there is not a large amount of measurement noise both exist.

By performing the high resolution 3-dimensional shape information generating processing for step S307 on the 3-dimensional shape information that has been generated by the above-described method, it becomes possible to generate high resolution 3-dimensional shape information in which the measurement inconsistencies have been reduced.

### Third Embodiment

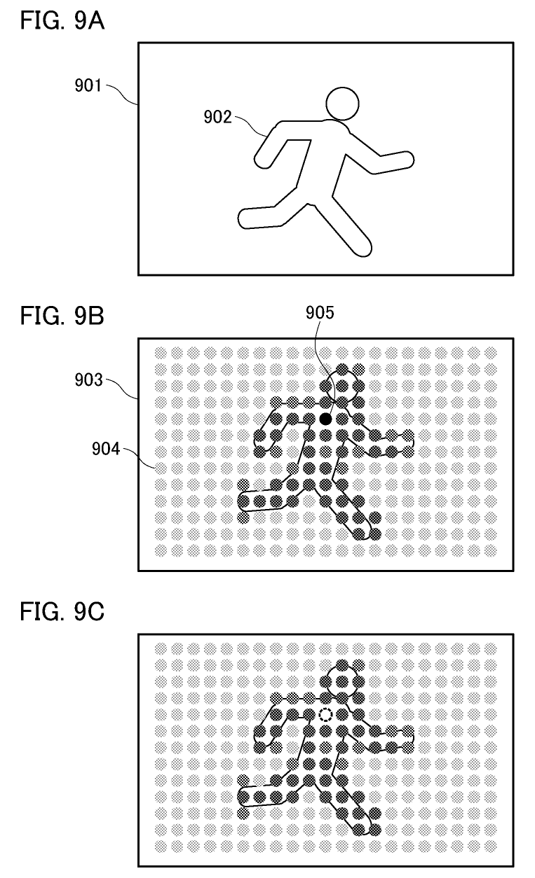

FIGS. 9 (A) to (C)are diagrams for explaining the processing contents for the 3-dimensional shape information correction in the Third Embodiment. Using FIGS. 9(A) to (C) , the 3-dimensional shape information update processing for step S703 and the 3-dimensional shape information sampling processing for step S704 that use the image feature amounts in the Third Embodiment will be explained.

FIGS. 9 (A) shows an image diagram for the image information, FIGS. 9 (B) shows a distance map image diagram serving as the 3-dimensional shape information, and FIGS. 9 (C) shows a distance map image diagram for after the 3-dimensional shape information update processing for step S703 and the 3-dimensional shape information sampling processing for step S704 have been performed.

As is shown in FIGS. 9 (A), the person 902 that serves as the image information is the subject, and during the image feature amount extraction processing for step S706 in FIG. 7, it is made such that the region for the person 902 is extracted. FIGS. 9 (B) shows a distance map 903 that serves as 3-dimensional shape information, and for the sake of the explanation, this is shown as overlapping with the image information for FIGS. 9 (A).

In FIGS. 9 (B), 904 is the distance information for the measurement point, and it is made such that the deeper the shade for the measurement point is, the smaller the distance information is. In the present embodiment, during the 3-dimensional shape information update processing for step S703, a subject classification that has been extracted as the image feature amount is compared with the distance information for the measurement point corresponding to the subject, and measurement points that have physically impossible distance information are eliminated as outlier values.

For example, when the distance information corresponding to the person 902, which is the subject in FIGS. 9(b), is approximately 10m, it is made such that the distance information for the measurement point 905 is made 5m. Even if as a generous estimate, it is assumed that the physical size of a person is within 1m, then it is possible to extract the measurement point 905 as an outlier value, and to obtain a distance map that has been corrected as is shown in FIGS. 9 (C).

In this manner, it may be made such that the 3-dimensional shape information correcting unit uses object recognition results for an image and excludes deviating points as outlier values based on the subject distance and the estimated size.

It is possible to find an approximation value for the subject distance as, for example, the average value for the distance information for the measurement point corresponding to the subject. In addition, it is sufficient if a table of permissible values for the length of the depth direction for each subject classification is prepared in advance, and the outlier values are eliminated by comparing the estimated value for the subject distance with the distance information, which is the measurement value. In addition, the distribution of the distance information for the subject, and the like may also be used, comparison may be compared with the above-described table, and the outlier values may be eliminated.

That is, it may also be made such that the 3-dimensional shape information correcting unit 207 specifies the subject classification and the subject region based on the image feature amounts, and corrects the first 3-dimensional shape information based on the physical size of the subject classification.

It becomes possible to generate high definition 3-dimensional shape information in which measurement inconsistencies have been reduced by performing the high resolution 3-dimensional shape information generating processing of step S307 on the 3-dimensional shape information that has been generated according to the above-described method.

### Fourth Embodiment

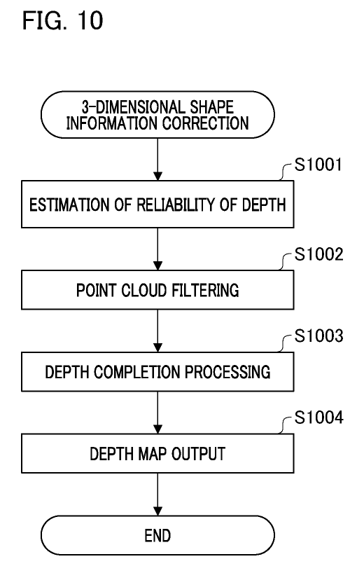

FIG. 10 is a flowchart showing a processing example for 3-dimensional shape information correction in the Fourth Embodiment, and shows a processing example for step S306 in FIG. 4. Note that the processes for each step in the flowchart of FIG. 10 are performed in order by a CPU and the like that serves as a computer inside of the 3-dimensional information processing apparatus 101 executing a computer program that has been stored on a memory.

During step S1001 of FIG. 10, the 3-dimensional shape information correcting unit estimates a reliability of depth for the first 3-dimensional shape information (LiDAR point cloud information) is estimated by using the reflection intensity. Note that in the Fourth Embodiment, the 3-dimensional shape information correcting unit makes the reliability of depth lower for subjects that have a luminance that is lower than a predetermined value, mirrored surfaces, transparent objects, and the like.

Next, during step S1002, the 3-dimensional shape information correcting unit filters the point cloud information based on the reliability of depth that was estimated during step S1001. That is, 3-dimensional shape information sampling is performed that makes the sampling density for point cloud information having a reliability of depth that is equal to or below a predetermined reliability of depth higher than the sampling density for other point clouds.

Furthermore, during step S1003, the 3-dimensional shape information correcting unit uses the method from, for example non patent publication (JJ. Park, K. Joo, Z. Hu, C. -K. Liu, and I. S. Kweon.: Nonlocal spatial propagation network for depth completion), and after having repeatedly performed point cloud sampling and depth completion processing for the low reflection intensity region and increasing the sampling density, integration processing is performed.

After this, during step S1004, using the results from the above integration processing, the corrected 3-dimensional shape information is output as a depth map, and the processing flow for FIG. 10 is completed.

In this manner, in the Fourth Embodiment, 3-dimensional shape information correction with increased sampling density becomes possible by estimating the reliability of depth and using this.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the 3-dimensional information processing apparatus, and the like through a network or various storage media. Then, a computer (or a CPU, an MPU, or the like) of the 3-dimensional information processing apparatus, and the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of Japanese Patent Application No. 2025-074367, filed on Apr. 28, 2025, which is hereby incorporated by reference herein in its entirety.

What is claimed is:

1. A 3-dimensional information processing apparatus comprising at least one processor, and a memory coupled to the at least one processor, the memory storing instructions that, when executed by the at least one processor, cause the at least one processor to:
use first 3-dimensional shape information that has been acquired by a distance measurement apparatus and image information that has been acquired by an image acquisition apparatus, and generate second 3-dimensional shape information that has a higher resolution in comparison to the first 3-dimensional shape information; and
use measurement time information for the first 3-dimensional shape information and correct the first 3-dimensional shape information.

2. The 3-dimensional information processing apparatus according to claim 1, wherein the distance measurement apparatus is configured to acquire the first 3-dimensional shape information by using at least one of electromagnetic waves, and acoustic waves.

3. The 3-dimensional information processing apparatus according to claim 1, wherein the measurement time information includes information relating to a reflected wave corresponding to the first 3-dimensional shape information from when the 3-dimensional shape information was acquired.

4. The 3-dimensional information processing apparatus according to claim 3, wherein the first 3-dimensional shape information and the second 3-dimensional shape information include point cloud information.

5. The 3-dimensional information processing apparatus according to claim 4, wherein the information relating to the reflected wave includes reflection intensity, and wherein the memory stores further instructions that, when executed by the at least one processor, cause the at least one processor to:
estimate a reliability of depth for the point cloud information by using the reflection intensity, and filter the point cloud information based on the reliability of depth.

6. The 3-dimensional information processing apparatus according to claim 5, wherein the memory stores further instructions that, when executed by the at least one processor, cause the at least one processor to:
make the reliability of depth lower for subjects with a luminance that is lower than a predetermined value, mirror surfaces, and transparent objects.

7. The 3-dimensional information processing apparatus according to claim 5, wherein the memory stores further instructions that, when executed by the at least one processor, cause the at least one processor to:
make sampling densities for point clouds for regions with a low reflection intensity higher.

8. The 3-dimensional information processing apparatus according to claim 5, wherein the memory stores further instructions that, when executed by the at least one processor, cause the at least one processor to:
perform averaging processing using neighboring point clouds on regions with a low reflection intensity.

9. The 3-dimensional information processing apparatus according to claim 5, wherein the memory stores further instructions that, when executed by the at least one processor, cause the at least one processor to:
perform point cloud classification based on image segmentation processing, and perform averaging processing on same-subject regions.

10. The 3-dimensional information processing apparatus according to claim 5, wherein the memory stores further instructions that, when executed by the at least one processor, cause the at least one processor to:
use object recognition results for an image, and eliminate deviating points as outlier values based on a subject distance and estimated size.

11. The 3-dimensionl information processing apparatus according to claim 5, wherein the memory stores further instructions that, when executed by the at least one processor, cause the at least one processor to:
perform point cloud sampling and depth completion processing for low reflection intensity regions a plurality of times, and perform integration processing.

12. The 3-dimensional information processing apparatus according to claim 1, wherein the memory stores further instructions that, when executed by the at least one processor, cause the at least one processor to:
correct the first 3-dimensional shape information by using at least one of the first 3-dimensional shape information and the measurement time information, together with image feature amounts that have been extracted from the image information.

13. The 3-dimensional information processing apparatus according to claim 12, wherein the image feature amount includes at least one of a pixel value in the image information, color-space coordinate values, object detection results from inside an image, and segmentation results in which an object has been detected.

14. The 3-dimensional information processing apparatus according to claim 12, wherein the memory stores further instructions that, when executed by the at least one processor, cause the at least one processor to:
specify a subject classification and a subject region based on the image feature amount, and correct the first 3-dimensional shape information based on a physical size of the object classification.

15. A 3-dimensional information processing method comprising:
using first 3-dimensional shape information that has been acquired by a distance measurement apparatus, and image information that has been acquired by an image acquisition apparatus, and generating second 3-dimensional shape information that has a high resolution in comparison to the first 3-dimensional shape information; and
using measurement time information for the first 3-dimensional shape information and correcting the first 3-dimensional shape information.

16. A non-transitory computer-readable storage medium storing a computer program including instructions for executing the following processes:
using first 3-dimensional shape information that has been acquired by a distance measurement apparatus, and image information that has been acquired by an image acquisition apparatus, and generating second 3-dimensional shape information that has a high resolution in comparison to the first 3-dimensional shape information; and
using measurement time information for the first 3-dimensional shape information and correcting the first 3-dimensional shape information.
